(19) United States
(12) Patent Application Publication
(10) Pub. No.: US 2009/0323497 A1
(43) Pub. Date: Dec. 31, 2009

(54) OPTICAL RECORDING APPARATUS

(75) Inventor: James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.., Eindhoven (NL)

(21) Appl. No.: 12/305,027

(22) PCT Filed: Jun. 5, 2007
(86) PCT No.: PCT/IB2007/052102

§ 371 Date: Dec. 16, 2008

(30) Foreign Application Priority Data
Jun. 19, 2006 (EP) 06115642.8

(51) Int. Cl. G11B 7/00

(52) U.S. Cl. 369/100; G9B/7

(57) ABSTRACT

The present invention relates to an optical recording apparatus with processing means (50) arranged for processing encoded data (NRZ). The processing means further has demultiplexing means (DEMUX) arranged for demultiplexing the encoded data (NRZ) into a first plurality (m) of data channels (65) using a second clock frequency signal (CLK2). The data channels are transmitted through a flexible transmission path (40) where each data channel (65) has at least one electrical conductor means (41) for each data channel. In the optical pick-up unit (OPU; 20) synchronising by retiming means (23) of the first plurality (m) of data channels (65) using the first clock frequency signal (CLK1) takes place. Thereby, the optical recording apparatus will have an increased effective bandwidth between the processing means (50) of the optical recording apparatus, and the optical pick-up unit (OPU; 20) by nature of the parallel transmission of the plurality of data channels (65).

The present invention relates to an optical recording apparatus, corresponding processing means for controlling an optical recording apparatus, and a corresponding method for operating an optical recording apparatus. In particular, the present invention provides improved writing speed for an optical recording apparatus.

An optical recording drive normally has a displaceable optical pick-up unit (OPU) positioned in opposed and proximate relationship to the optical disk. The OPU is then connected to a central digital signal processor (DSP) via a flexible signal transmission path section, also known in the art as the “flex” or “flex cable”. The path section may be a plurality of flat conducting lines sandwiched between two films or a set of collected coated flexible wires. The flex allows for sufficient displacement of the OPU while simultaneously keeping the OPU connected to the DSP. The DSP (or a similar unit) controls the operation of the OPU and feeds the OPU with encoded data and a clocking signal, see e.g. US patent application 2004/033814.

Within the optical pick-up unit (OPU), a laser is positioned for writing so that during optical recording of an optical disk or carrier, for rewriteable media, a laser beam is applied to selectively crystallize or make amorphous a phase-changing material in dependency of the data to be written on the optical disk or carrier. Equally, for write-once media, a laser beam is applied to selectively alter/burn away/deform (dye) material or not, in dependency of the data to be writing on the optical disk or carrier.

The laser is driven by using a pulse form that contains higher frequency components than the channel rate itself. This has the form of a multi-level pulse with the purpose of writing a “mark” or a “space” at a given length in response to the encoded data. The conversion of encoded data, also known as no-return-to-zero data (NRZ), alternatively eight-to-fourteen modulated (EFM) data, to a pulse train with higher time resolution and multiple power levels is performed by a so-called write strategy generator (WSG) located on the OPU.

With the current trend of increasing writing speed to the optical disk, in particular for the Blu-Ray Disc (BD), the parallel transmission of encoded data and a clocking signal from the DSP to the OPU is approaching an upper limit. This is because the bandwidth of the flex is limited due to the usual physical design restrictions and, and length differences within the flex plus variable flex position due to OPU movement (causing varying capacitive load) result in various frequency, and position dependent signal propagation delays in the transmitted data and/or the clock signal. Moreover, the encoded data need a reliable set-up and hold time relative to the clocking signal. Estimates show that the BD 7× writing speed (500 MHz/2 nanoseconds) represents such an upper limit.

A solution for reducing the constraints imposed by flex, and in turn increasing the writing speed of the optical drive, is disclosed in US patent application 2004/0179451. By providing the DSP with a square-waveform transmitter and the OPU with a corresponding receiving means, in particular a square-waveform modifying means, the transmission speed to the OPU is increased. This is performed by allowing the square-waveform modifying means to raise (or lower) the rising level (or falling) edge of the incoming square-waveform so as to increase the transmission frequency. However, this solution does not effectively solve the transmission problem, because this solution essentially seeks to mitigate the physical design restrictions imposed by the flex, and does not improve or lift the design restrictions of the flex.

Hence, an improved optical recording apparatus would be advantageous, and in particular a more efficient and/or reliable optical recording apparatus would be advantageous.

Accordingly, the invention preferably seeks to mitigate, alleviate or eliminate one or more of the above mentioned disadvantages singly or in any combination. In particular, it may be seen as an object of the present invention to provide an optical recording apparatus that solves the above-mentioned problems of the prior art regarding high speed writing.

This object and several other objects are obtained in a first aspect of the invention by providing an optical recording apparatus for recording information on an associated optical carrier, said apparatus comprising:

processing means arranged for processing encoded data (NRZ), said processing means comprising clock generating means capable of generating a first clock frequency signal (CLK1), said processing means further comprising demultiplexing means arranged for demultiplexing the encoded data (NRZ) into a first plurality (m) of data channels using a second clock frequency signal (CLK2),

an optical pick-up unit (OPU) comprising an irradiation source and a corresponding drive device (LDD), the drive device comprising retiming means adapted for synchronising the first plurality (m) of data channels with the first clock frequency signal (CLK1), and

a flexible transmission path operably connecting the optical pick-up unit (OPU) with the processing means, said flexible transmission path comprising at least one electrical conductor means for each data channel within the first plurality (m) of data channels.

The invention is particularly, but not exclusively, advantageous for obtaining an optical recording apparatus with an increased effective bandwidth between the processing means of the optical recording apparatus and the optical pick-up unit (OPU) by nature of the parallel transmission of the plurality of data channels. In addition, the present invention is relatively easy to implement by already existing electronic components.

In one embodiment of the invention, the optical pick-up unit (OPU) may comprise multiplexing means for multiplexing the first plurality (m) of data channels into one or more (p) data channels after being output from the retiming means. If the number of data channels is two or more, it facilitates the possibility of operating the OPU at a lower clock frequency than otherwise possible.

Typically, the flexible transmission path, i.e. the flex, may further comprise at least one electrical conductor means for transmitting the first clock frequency (CLK1) signal to the optical pick-up unit (OPU). This provides a straightforward possibility that the first plurality (m) of data channels can be synchronised on the OPU by using the first clock frequency (CLK1). As an alternative, the first clock frequency (CLK1) could be generated on the OPU.

The at least one electrical conductor means forms part of a differential signal connection, e.g. a two-level LVDS connection or the like. Alternatively, the at least one electrical conductor means may form part of serial signal connection depending on the requirements to the frequency and/or the electromagnetic shielding needed (EMC).

Advantageously, the drive device (LDD) may further comprise clock detection means such as a zero level detector, a middle level detector or the like. In that case, the drive device (LDD) may further comprise clock generation means connected to the clock detection means so as to retrieve a robust clock signal. The clock generation means may for instance be a PLL circuit or the like.

Beneficially, the second clock frequency signal (CLK2) may be derived from the first clock frequency signal (CLK1) e.g. by frequency dividers in order to provide a simple and reliable connection between the two clock signals. This has the advantage that design and implementation of the invention is simplified.

In several advantageous embodiments, the optical pick-up unit (OPU) may comprise a write strategy generator adapted for receiving a plurality (m; p) of parallel encoded data channels. As mentioned above, this gives the possibility of operating the OPU at a lower clock frequency than otherwise possible.

In order to facilitate a reliable and stable optical recording, the apparatus may further be adapted to perform a calibration procedure of the first plurality (m) of data channels by detecting phase differences of transmitted test signals adapted so as to obtain an optimum transmission phase for the plurality of data channels.

In a second aspect, the invention relates to processing means adapted to control an associated optical recording apparatus for recording information on an associated optical carrier, the processing means being arranged for processing encoded data (NRZ), said processing means comprising:

clock generating means capable of generating a first clock frequency signal (CLK1), and

demultiplexing means arranged for demultiplexing the encoded data (NRZ) into a first plurality (m) of data channels using a second clock frequency signal (CLK2), said plurality of data channels intended for being transmitted to an optical pick-up unit (OPU) of the associated optical recording apparatus through a flexible transmission path operably connecting the optical pick-up unit (OPU) with the processing means, said flexible transmission path comprising at least one electrical conductor means for each data channel within the first plurality (m) of data channels.

In a third aspect, the invention relates to a method for operating an optical recording apparatus for recording information on an optical carrier, the method comprising the steps of:

processing by processing means encoded data (NRZ), said processing means comprising clock generating means capable of generating a first clock frequency signal (CLK1),

demultiplexing by demultiplexing means the encoded data (NRZ) into a first plurality (m) of data channels using a second clock frequency signal (CLK2),

transmitting through a flexible transmission path each data channel within the first plurality (m) of data channels by said flexible transmission path, said path operably connecting the optical pick-up unit (OPU) with the processing means and said path further comprising at least one electrical conductor means for each data channel, and

synchronising by retiming means the first plurality (m) of data channels using the first clock frequency signal (CLK1).

In a fourth aspect, the invention relates to a computer program product being adapted to enable a computer system comprising at least one computer having data storage means associated therewith to control an optical recording apparatus according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical recording apparatus may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

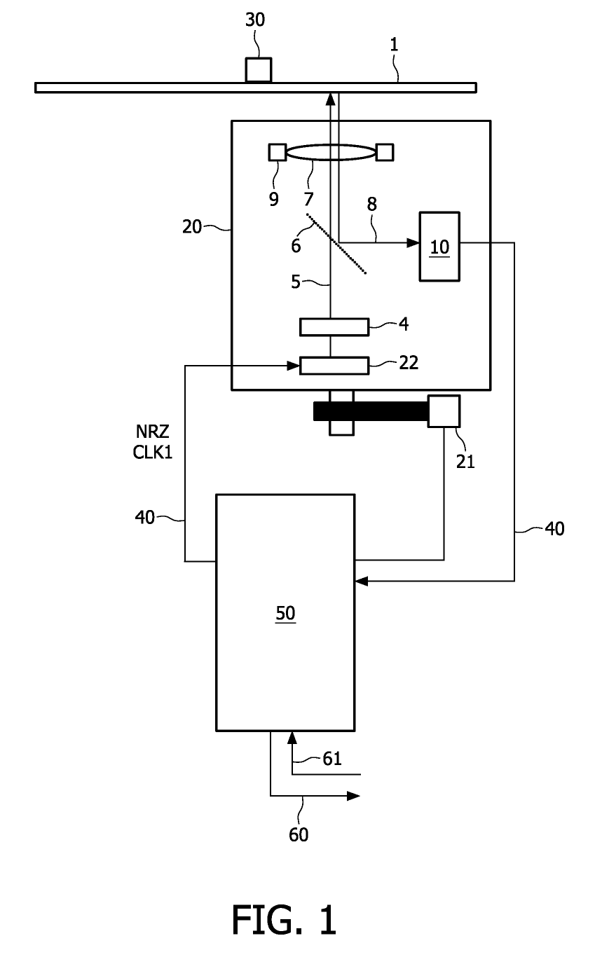

FIG. 1 schematically shows an optical recording apparatus or drive and an optical information carrier according to the present invention,

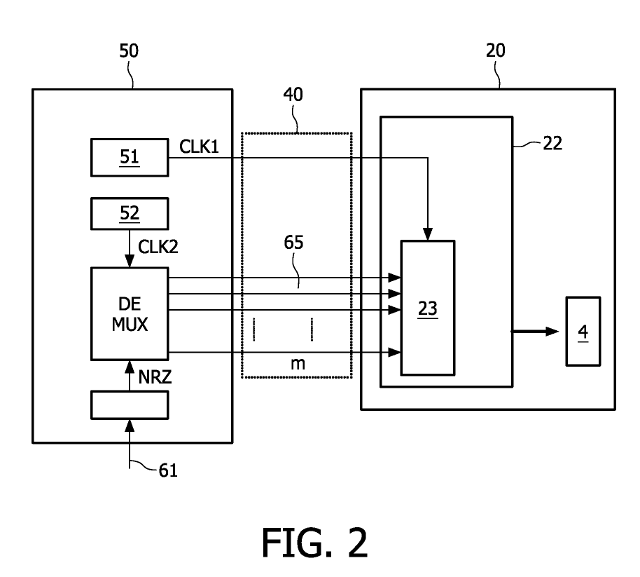

FIG. 2 schematically shows processing means, optical pick-up unit (OPU), and the flexible transmission path connecting the processing means and the optical pick-up unit (OPU) according to the invention,

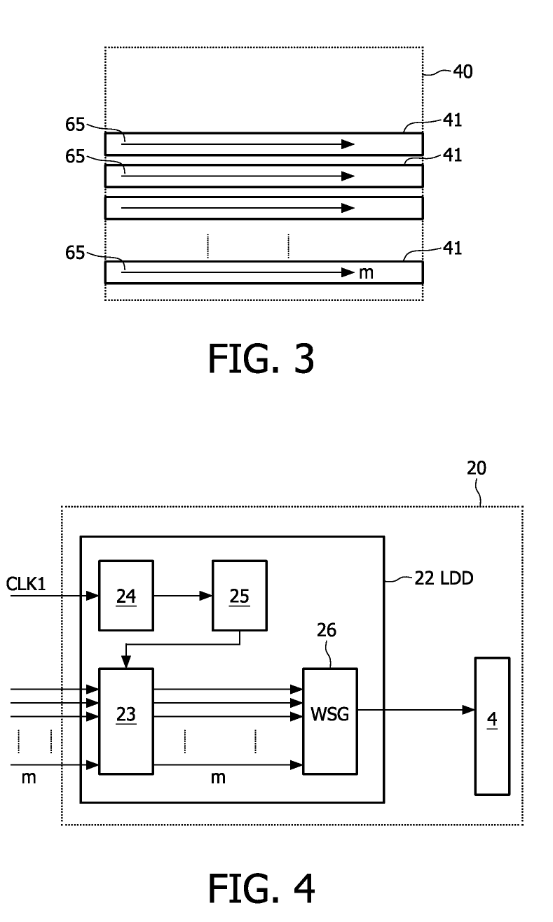

FIG. 3 schematically shows the flexible transmission path according to the present invention,

FIG. 4 schematically shows an embodiment of the optical pick-up unit (OPU) according to the present invention,

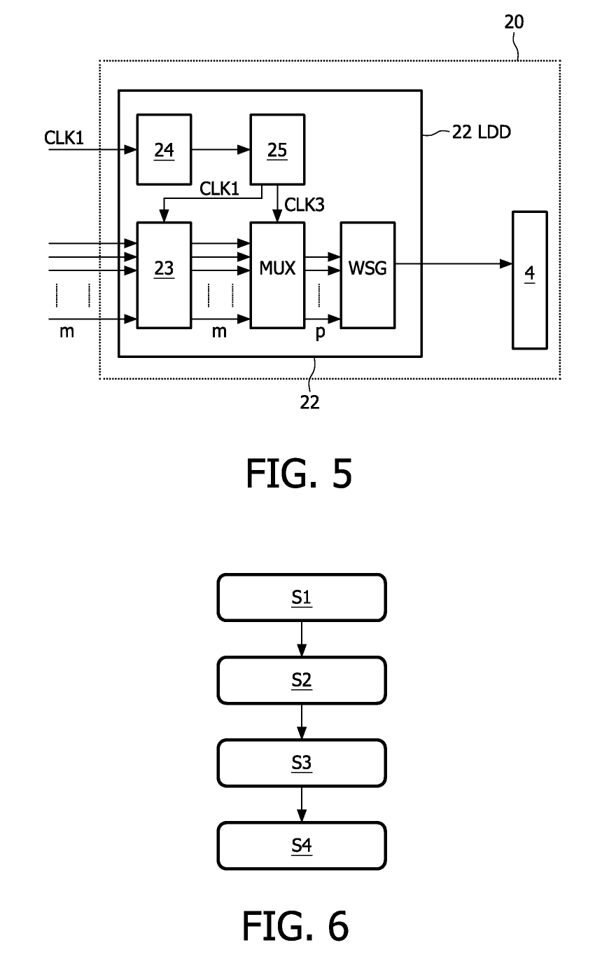

FIG. 5 schematically shows an alternative embodiment of the optical pick-up unit (OPU) according to the present invention, and

FIG. 6 is a flow-chart of a method according to the invention.

FIG. 1 shows an optical recording apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable effects, also called “marks” for rewriteable media and “pits” for write-once media, on the optical carrier 1.

The optical apparatus, i.e. the optical drive, comprises an optical head 20, sometimes called an optical pick-up (OPU), the optical head 20 being displaceable by actuation means 21, e.g. an electric stepping motor. The optical head 20 comprises a photo detection system 10, a laser driver device 30, a radiation source 4, a beam splitter 6, an objective lens 7, and lens displacement means 9 capable of displacing the lens 7 both in a radial direction of the carrier 1 and in the focus direction.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where a commonly known servomechanism operated by using PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc.

The radiation source 4 is controlled by the laser driver device (LD) 22. The laser driver (LD) 22 comprises electronic circuitry means (not shown in FIG. 1) for providing a drive current to the radiation source 4 in response to a first clock signal CLK1 and a data signal NRZ transmitted from the processor 50 through the common transfer path 40, i.e. the flex.

The processor 50 also receives and analyses signals from the photo detection means 10 through the common transfer path 40. The processor 50 can also output control signals to the actuation means 21, the radiation source 4, the lens displacement means 9, and the rotating means 30, as schematically illustrated in FIG. 1. Similarly, the processor 50 can receive data to be written, indicated at 61, and the processor 50 may output data from the reading process as indicated at 60. While the processor 50 has been depicted as a single unit in FIG. 2, it is to be understood that equivalently the processor 50 may be a plurality of interconnecting processing units positioned in the optical recording apparatus, possibly some of the units may be positioned in the optical head 20.

FIG. 2 schematically shows the processing means 50, the optical pick-up unit (OPU) 20, and the flexible transmission path 40 interconnecting processing means 50 and the optical pick-up unit (OPU) 20.

The processing means 50 is arranged for processing encoded data NRZ based on the received data 61 to be written on the carrier 1. The processing means 50 receives data 61 to be written on the optical carrier 1 (not shown in FIG. 2). The data is initially encoded by a conventional encoder 53. The encoding is performed according to the appropriate format of the carrier 1. Data recording on various carrier formats, such as the compact disc (CD) format, the digital versatile disc (DVD), and the Blu-Ray disc (BD), is performed by encoding the data 61 according to a standard encoding scheme to obtain a NRZ signal to be transmitted to the optical head 20 for writing. In the table below, corresponding carrier formats and encoding schemes are listed:

| Carrier formats | Encoding scheme |
|---|---|
| CD | 2.10 EFM |
| DVD | 2.10 EFM+ |
| BD | 1.7 PP |

EFM is the commonly known abbreviation for Eight-to-Fourteen Modulation, and PP is an abbreviation for partial product. The present invention is not limited to the above listed carrier formats. Rather, the invention is particularly suited for obtaining high writing speeds on optical carriers in general.

The processing means 50 has first clock generating means 51 and second clock generating means 52 capable of generating a first clock frequency signal CLK1 and a second clock frequency signal CLK2, respectively. The clock generating means 52 uses the first clock signal CLK1 to derive the second clock signal CLK2 by e.g. frequency division or similar methods. The frequency of the second frequency signal CLK2 is thereby related to the first clock frequency signal CLK1 by being smaller, and preferably substantially equal to the frequency of the first clock frequency signal CLK1 divided by an integer. In one embodiment, the said integer is equal to the number m of demultiplexed data channels 65 as this simplifies design of the optical recording apparatus.

The first clock frequency signal CLK1 can be derived from the clock frequency signal CLK using well-known clock synthesis methods (e.g. PLL). Alternatively, if less accuracy is required, then the first clock frequency signal CLK1 could be retrieved or recovered from the associated encoded data NRZ, the so-called NRZ clock or EFM clock using well-known clock recovery techniques. In particular, it could be of substantially the same frequency as the NRZ clock.

The frequency of the first clock frequency signal and/or the frequency of the data channels 65 CLK1 could, e.g. for Blu-Ray Disc (BD) writing, be in the interval from 50-500 MHz, or 100-400 MHz, or alternatively 200-300 MHz. The frequency of the first clock frequency signal CLK1 and/or the frequency of the data channels 65 could in another embodiment be limited to a maximum of 1000 MHz, 900 MHz, 800 MHz, 700 MHz, 600 MHz, 500 MHz, 400 MHz, 350 MHz, 300 MHz, 250 MHz, 200 MHz, 150 MHz, or 100 MHz. In particular, the frequency of the first clock frequency signal CLK and/or the frequency of the data channels 65 can be set below the frequency bandwidth of the flex 40 so as to obtain substantially undistorted transmission to the OPU 20. With the present flex cable technology, this limit is around 150 MHz to 200 MHz.

The processing means 50 further comprises demultiplexing means DEMUX arranged for demultiplexing the encoded data NRZ into a first plurality m of data channels using the second clock frequency signal CLK2. The demultiplexing of the NRZ data may be performed in many different ways, e.g. in the frequency domain or the time domain, readily available to the skilled person once the principle of the present invention has been realized.

The flexible transmission path 40 shown in more detail in FIG. 3 operably connects the optical pick-up unit (OPU) 20 with the processing means 50, and the path 40 thereby transmits the NRZ data to the OPU in the form of a first plurality m of data channels 65. The flexible transmission path 40 comprises at least one electrical conductor means 41 for each data channel 65 within the first plurality m of data channels. The electrical conductor means 41 is preferably a differential signal connection such as a low-voltage differential signal (LVDS) connection, but could also be a single serial connection depending on the frequency requirements and the electromagnetic shielding (EMC) needed. The number m of data channels 65 may be 2, 3, 4, 5, 6, 7, 8, 9, 10, 11, 12, 13, 14, 15, 16, 17, 18, 19, 20 or higher.

As shown in FIG. 2, the optical pick-up unit (OPU) 20 comprises an irradiation source 4 and a corresponding drive device (LDD) 22 for controlling the writing operation of the irradiation source 4, e.g. a solid-state laser. The drive device 22 in particular comprises retiming means 23 adapted for synchronising the first plurality m of data channels 65 with the first clock frequency signal CLK1. The first clock frequency signal CLK1 is transmitted to the OPU 20 via the path 40 in parallel with the encoded data channels 65.

FIG. 4 schematically shows an embodiment of the optical pick-up unit (OPU) 20, where the received first clock frequency signal CLK1 is processed by clock detection means 24. For if the first clock frequency signal CLK1 is transmitted via LVDS connection, the clock detection means 24 could be a zero-level comparator or the like. The detected clock signal is further transmitted from the clock detection means 24 to the clock generator 25. Said clock generator 25 could be a phase locked loop (PLL) circuit or the like for retrieving the first clock frequency signal CLK1 or derivates thereof in a stable and robust fashion. From the clock generator 25 the first clock frequency signal CLK1 is transmitted to the retiming means 23 for synchronizing the demultiplexed data channels 65.

From the retiming means 23 the plurality of demultiplexed data channels 65 are further transmitted to the write strategy generator (WSG) 26, which is adapted for processing parallel received data. Subsequently, the write strategy generator (WSG) 26 emits a corresponding write pulse train to the irradiation source 4 so as to write information to the optical carrier 1 (not shown in FIG. 4).

FIG. 5 schematically shows an alternative embodiment of the optical pick-up unit (OPU) 20 similar to the embodiment shown in FIG. 4. However, in the embodiment of FIG. 4 the plurality of m data channels 65 is, subsequent to retiming by retiming means 23, transmitted to a multiplexer MUX for multiplexing the data channels 65 into one or more data channels, i.e. p data channels, where p is larger than or equal to 1 (p≧1). For this multiplexing process a third clock signal CLK3 is generated by the clock generator 25 and transmitted to the MUX. As a special embodiment the number of resulting data channels could be one (p=1), whereby an original serial NRZ data signal is retrieved.

As an illustrative example, BD writing at 8× writing speed (528 MHz) may be considered. In that embodiment, the frequency of the first clock frequency signal CLK1 may be a quarter of the channel clock frequency of 528 MHz, i.e. 132 MHz, the frequency of the second clock frequency signal CLK2 may then be obtained by similar (or the same) frequency division of CLK1 (e.g. also yielding 132 MHz data) and setting the number of demultiplexed data channels 65 to 4 (m=4). On the receiving side, the driver device 22 may further down-multiplex the data channels 65 from m=4 to p=2. The write strategy generator WSG is then adapted for receiving and processing a dual data stream. In another example, the number of demultiplexed data channels may be set to two (m=2), which may be down-multiplexed to a serial signal (p=1) transmitted to the write strategy generator (WSG) 26.

In order to facilitate a reliable and stable optical recording, the apparatus may further be adapted to perform a calibration procedure of the first plurality m of data channels 65 by detecting phase differences of transmitted test signals so as to adapt an optimum transmission phase for the plurality of data channels. In one embodiment, various test signals having different phases are transmitted through the data channels 65, and if upon analysis at the receiving side (i.e. the OPU 20) of the test phases a phase jump is observed, that given test phase is undesirable, and hence transmission can be performed at 180 degrees shifted from that particular test phase.

FIG. 6 is a flow-chart of a method according to the invention. The method comprises the steps of:

S1 processing by processing means 50 encoded data (NRZ), said processing means comprising clock generating means 51 capable of generating a first clock frequency signal CLK1,

S2 demultiplexing by demultiplexing means DEMUX the encoded data (NRZ) into a first plurality m of data channels 65 using a second clock frequency signal CLK2,

S3 transmitting through a flexible transmission path 40 each data channel 65 within the first plurality m of data channels 65 by said flexible transmission path 40, said path operably connecting the optical pick-up unit (OPU) 20 with the processing means 50 and said path further comprising at least one electrical conductor means 41 for each data channel 65, and

S4 synchronising by retiming means 23 the first plurality m of data channels 65 using the first clock frequency signal CLK1.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical recording apparatus for recording information on an associated optical carrier (1), said apparatus comprising:
processing means (50) arranged for processing encoded data (NRZ), said processing means comprising clock generating means (51) capable of generating a first clock frequency signal (CLK1), said processing means further comprising demultiplexing means (DEMUX) arranged for demultiplexing the encoded data (NRZ) into a first plurality (m) of data channels (65) using a second clock frequency signal (CLK2),
an optical pick-up unit (OPU; 20) comprising an irradiation source (4) and a corresponding drive device (LDD; 22), the drive device comprising retiming means (23) adapted for synchronising the first plurality (m) of data channels (65) with the first clock frequency signal (CLK1), and
a flexible transmission path (40) operably connecting the optical pick-up unit (OPU; 20) with the processing means (50), said flexible transmission path comprising at least one electrical conductor means (41) for each data channel (65) within the first plurality (m) of data channels (65).

2. An apparatus according to claim 1, wherein the optical pick-up unit (OPU; 20) comprises multiplexing means (MUX) for multiplexing the first plurality (m) of data channels (65) into one or more (p) data channels.

3. An apparatus according to claim 1, wherein the flexible transmission path (40) further comprises at least one electrical conductor means (41) for transmitting the first clock frequency (CLK1) signal to the optical pick-up unit (OPU; 20).

4. An apparatus according to claim 1, wherein the at least one electrical conductor means (41) forms part of a differential signal connection.

5. An apparatus according to claim 1, wherein the at least one electrical conductor means (41) forms part of serial signal connection.

6. An apparatus according to claim 3, wherein the drive device (LDD; 22) further comprises clock detection means (24).

7. An apparatus according to claim 6, wherein the drive device (LDD; 22) further comprises clock generation means (25) connected to said clock detection means (24).

8. An apparatus according to claim 1, wherein the second clock frequency signal (CLK2) is derived from the first clock frequency signal (CLK1).

9. An apparatus according to claim 1, wherein the optical pick-up unit (OPU; 20) comprises a write strategy generator (WSG; 26) adapted for receiving a plurality (m; p) of parallel encoded data channels (65).

10. An apparatus according to claim 1, wherein the apparatus is further adapted to perform a calibration procedure of the first plurality (m) of data channels (65) by detecting phase differences of transmitted test signals.

11. Processing means (50) adapted to control an associated optical recording apparatus for recording information on an associated optical carrier (1), the processing means being arranged for processing encoded data (NRZ), said processing means comprising:
clock generating means (51) capable of generating a first clock frequency signal (CLK1), and
demultiplexing means (DEMUX) arranged for demultiplexing the encoded data (NRZ) into a first plurality (m) of data channels (65) using a second clock frequency signal (CLK2), said plurality of data channels (65) intended for being transmitted to an optical pick-up unit (OPU; 20) of the associated optical recording apparatus through a flexible transmission path (40) operably connecting the optical pick-up unit (OPU; 20) with the processing means (50), said flexible transmission path comprising at least one electrical conductor means (41) for each data channel within the first plurality (m) of data channels (65).

12. A method for operating an optical recording apparatus for recording information on an optical carrier (1), the method comprising the steps of:
processing by processing means (50) encoded data (NRZ), said processing means comprising clock generating means (51) capable of generating a first clock frequency signal (CLK1),
demultiplexing by demultiplexing means (DEMUX) the encoded data (NRZ) into a first plurality (m) of data channels (65) using a second clock frequency signal (CLK2),
transmitting through a flexible transmission path (40) each data channel (65) within the first plurality (m) of data channels (65) by said flexible transmission path, said path operably connecting the optical pick-up unit (OPU; 20) with the processing means (50) and said path (40) further comprising at least one electrical conductor means for each data channel, and
synchronising by retiming means (23) the first plurality (m) of data channels (65) using the first clock frequency signal (CLK1).

13. A computer program product being adapted to enable a computer system comprising at least one computer having data storage means associated therewith to control an optical recording apparatus according to claim 12.
